(19) United States
(12) Patent Application Publication
(10) Pub. No.: US 2018/0240183 A1
(43) Pub. Date: Aug. 23, 2018

(54) METHOD AND APPARATUS FOR PROVIDING UNIQUE IDENTIFIER FOR PACKAGING ITEM

(71) Applicant: HUHTAMÄKI OYJ, Espoo (FI)

(72) Inventor: Timo Tiilikainen, Valkeakoski (FI)

(21) Appl. No.: 15/753,542

(22) PCT Filed: Aug. 19, 2016
(86) PCT No.: PCT/FI2016/050568

§ 371 Date: Feb. 19, 2018

(30) Foreign Application Priority Data
Aug. 19, 2015 (GB) 1514718.4

(51) Int. Cl. G06Q 30/06; G06Q 10/08; G06F 17/30

(52) U.S. Cl. CPC G06Q 30/0635; G06F 17/30879; G06Q 10/0838

(57) ABSTRACT

A method and an apparatus for receiving, by a system server, an order request for at least one ordered item from a client device; associating, by the system server, a unique identifier with a client and the order request, wherein the unique identifier being attached to a packaging item for delivering an ordered item for the client; and detecting, by a scanning device, the unique identifier to generate order status information for the system server.

### TECHNICAL FIELD

The present application generally relates to a method, a system and an apparatus for providing unique identifier for a packaging item. The present application further relates to a method, a system and an apparatus for associating a unique identifier of a packaging item with an information system. Furthermore, the present application further relates to a method, a system and an apparatus for providing order status information based on the unique identifier.

### BACKGROUND

Typically, ordering goods or services involves client identification or authentication, at the latest when paying the order. Services also exist that enable clients to register to a service and enable to operate a service system after that with a user name.

Services also exist, where a client may place an order as anonymous but either the client or the service provider needs to generate an identifier for the anonymous client to identify the service order or request made by the anonymous client. This requires complex mechanisms implemented and may degrade of interoperability of devices within today's world filled with different kinds of smart phones, tablets and other similar devices. On top of that, payment systems always require trusted and secure mechanisms that need to be linked to the system as well.

In today's world, clients use more and more electronic devices for ordering services or goods. At the same time, people tend to desire avoiding any unnecessary registrations to new systems or revealing their personal details. Furthermore, fluent delivery of ordered items is highly appreciated without a need for unnecessary waiting times, and time frame between making an order and picking the order up is critical. Unawareness of the status of the order should be minimized. At the same time the reliability of the order process should not be risked.

Currently, when a client makes an order request, a staff member needs to print at the counter a sticker label and attach it manually to a packaging item to identify what ordered items the packaging item comprises. Such process requires purchase and maintenance of additional printing devices and costly label materials. Such process is also cumbersome, slow and ineffective in light of costs and staff resources. Optionally, in current order process systems, the client receives a guest pager device that alarms the client when the ordered item is ready for being fetched from the service desk, for example.

Thus, a solution for anonymous ordering is needed. Such solution should improve the speed and reliability of the order process and should enhance the availability and effectiveness of the order request, payment and delivery between clients and service providers.

### SUMMARY According to a first example aspect of the invention there is provided a method comprising:

determining, by a system server, a packaging type for delivering an ordered item for a client based on an order request;
selecting, by the system server, a unique identifier for a packaging item of the determined packaging type, wherein the unique identifier being attached to the packaging item during manufacturing phase of the packaging item;
receiving, by the system server, the order request for at least one ordered item from a client device;
generating additional information, by a service provider, associated with the unique identifier;
associating, by the system server, the unique identifier with a client and the order request with the additional information, wherein the unique identifier being attached to a packaging item for delivering the ordered item for the client; and
detecting, by a scanning device, the unique identifier to generate order status information for the system server.

In an embodiment, the method further comprises:
generating, by the system server, feedback information for the client based on the order status information.

In an embodiment, the unique identifier comprising at least one of the following: a series of characters; a unique e-mail address; a RF-ID chip; a NFC chip; a bar code; a quick response (QR) code; and a pictogram.

In an embodiment, the method further comprises:
transmitting, by the system server, the feedback information to the client device during the order request being processed and before the ordered item being ready to be delivered.

In an embodiment, the method further comprises:
transmitting, by the system server, the feedback information to the client device after the order request is processed and when the ordered item being ready to be delivered by the client.

In an embodiment, the method further comprises:
providing additional information associated with the unique identifier to the client for assisting picking up of the ordered item.

In an embodiment, the method further comprises:
associating, by the system server, the unique identifier with the additional information comprising at least one of the following:
   an identity of an external service or a database;
   a textual phrase;
   a reference to other unique information of the packaging item;
   a unique pictogram;
   a multimedia data item;
   a game application;
   a reference to a color;
   a promotional code;
   a lottery number;
   location information; and
   information assisting picking up the order.

In an embodiment, the method further comprises:
arranging the at least one of the unique identifier and the additional information to be readable by the client or the client device when the ordered item being ready to be delivered.

In an embodiment, the method further comprises:
arranging the packaging item of the packaging type for delivering the ordered item for the client based on the order request, on a smart table, when the ordered item being ready to be delivered;
detecting, by the smart table, the unique identifier; and
displaying the at least one of the unique identifier and the additional information for the client or the client device.

In an embodiment, the scanning device comprises at least one of the following:
a scanner integrated to a service desk relating to a process for delivering the ordered item for the client based on the order request;
a smart table;
a scanner integrated to a client device;
a scanner integrated to a recycle bin;
a handheld scanner operated by a service provider employee; and
a scanner integrated to a service provider machine processing the ordered item.

In an embodiment, the scanner of the recycle bin is configured to detect and read the unique identifier of the packaging item to generate status information for the system server, the status information indicating that the packaging item being returned to the recycle bin, and further in response to such indication, the system server being configured to allocate balance credits to a user account and/or allocate content rewards to the client to be maintained by user profile information maintained by the system server.

In an embodiment, the method further comprises:
receiving, by the system server, an order request for a plurality of ordered items from the client device;
associating, by the system server, unique identifiers with a client and the order request, wherein a unique identifier being attached to each packaging item for delivering the plurality of ordered items for the client;
detecting, by the scanning device, the unique identifiers to generate order status information for the system server; and
generating, by the system server, feedback information for the client based on the order status information.

In an embodiment, the method further comprises:
attaching the unique identifier to the packaging item during the order request being processed.

In an embodiment, the method further comprises:
detecting, by a smart table, the unique identifier of the packaging item after the ordered item being delivered for the client;
providing, by the smart table, a set comprising a plurality of user applications based on the unique identifier;
receiving, by the smart table, selection information for a user application of the plurality of user applications; and
triggering the user application in response to the received selection information.

In an embodiment, the method further comprises: p1 detecting, by a smart table, the unique identifier of packaging item after the ordered item being delivered for the client; and
triggering, by the smart table, a user application based on the unique identifier.

In an embodiment, the user application comprises at least one of the following: a game application; an Internet browser application; a multimedia application; a social media application; and a commercial application.

In an embodiment, the packaging item comprises a disposable item.

In an embodiment, the method further comprises storing, by the system server, profile information for the client.

In an embodiment, the method further comprises storing, by the system server, a user account for the client, wherein the user account being a prepaid or a postpaid account to be used for charges and compensations relating to at least one ordered item.

In an embodiment, the order request comprises a plurality of ordered items to be delivered to the client using the same packaging item.

In an embodiment, the method further comprises associating, by the system server, the unique identifier with the client and the order request with the additional information, wherein the unique identifier being attached to the packaging item for delivering the plurality of ordered items for the client; and detecting, by a scanning device of a re-filler device to detect each re-filling of the packaging item.

In an embodiment, each re-filling of the packaging item is reduced from the plurality of ordered items that were ordered and purchased originally by the order request made by the client.

In an embodiment, the method further comprises in response to detecting the packaging item with the unique identifier received by a recycling bin, the unique identifier being allocated available for another disposable packaging item.

According to a second example aspect of the invention there is provided a system server comprising:
a communication interface for transceiving data;
at least one processor; and
at least one memory including computer program code, wherein the at least one memory and the computer program code configured to, with the at least one processor, cause the system server to:
   determine a packaging type for delivering an ordered item for a client based on an order request;
   select a unique identifier for the packaging item of the determined packaging type, wherein the unique identifier being attached to the packaging item during manufacturing phase of the packaging item;
   receive the order request for at least one ordered item from a client device;
   generate additional information associated with the unique identifier;
   associate the unique identifier with a client and the order request with the additional information, wherein the unique identifier being attached to the packaging item for delivering the ordered item for the client; and
   receive the detected unique identifier from a scanning device to generate order status information.

According to a third example aspect of the invention there is provided a computer program embodied on a computer readable medium comprising computer executable program code which, when executed by at least one processor of a system server, causes the system server to:
determine a packaging type for delivering an ordered item for a client based on an order request;
select a unique identifier for the packaging item of the determined packaging type, wherein the unique identifier being attached to the packaging item during manufacturing phase of the packaging item;
receive the order request for at least one ordered item from a client device;
generate additional information associated with the unique identifier;
associate the unique identifier with a client and the order request with the additional information, wherein the unique identifier being attached to the packaging item for delivering the ordered item for the client; and
receive the detected unique identifier from a scanning device to generate order status information.

According to a fourth example aspect of the invention there is provided a client device comprising:
a user interface for interacting with a client;
a communication interface for transceiving data;
at least one processor; and
at least one memory including computer program code; wherein the at least one memory and the computer program code configured to, with the at least one processor, cause the client device to:
transmit an order request for at least one ordered item to a system server, wherein a packaging type is determined for delivering an ordered item for the client based on the order request, a unique identifier is selected for the packaging item of the determined packaging type, the unique identifier is attached to a packaging item during manufacturing phase of the packaging item, additional information associated with the unique identifier is generated, the unique identifier is associated with a client and the order request with the additional information, wherein the unique identifier being attached to the packaging item for delivering the ordered item for the client; and for detecting, by a scanning device, the unique identifier to generate order status information for the system server.

In an embodiment, the at least one memory and the computer program code are further configured to, with the at least one processor, cause the client device to:
receive feedback information generated by the system server based on order status information, wherein the order status information being generated using a detected unique identifier received from a scanning device; the unique identifier being associated with the client and the order request by the system server; and the unique identifier being attached to a packaging item for delivering an ordered item for the client.

According to a fifth example aspect of the invention there is provided a packaging item comprising a unique identifier being attached to the packaging item during manufacturing phase of the packaging item, wherein the unique identifier being attached to the packaging item for delivering an ordered item for a client, further wherein a packaging type for delivering the ordered item for the client is configured to be determined, by a system server, based on an order request; the unique identifier is configured to be selected, by the system server, for the packaging item of the determined packaging type; the order request is configured to be received, by the system server, for at least one ordered item from a client device; additional information is configured to be generated, by the system server, associated with the unique identifier; the unique identifier is configured to be associated, by the system server, with a client and the order request with the additional information; and the detected unique identifier is configured to be received from a scanning device to generate order status information.

In an embodiment, the packaging item comprises a disposable packaging item.

Different non-binding example aspects and embodiments of the present invention have been illustrated in the foregoing. The embodiments in the foregoing are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

For a more complete understanding of example embodiments of the present invention, reference is now made to the following descriptions taken in connection with the accompanying drawings in which:

FIG. 1 shows a schematic picture of a system according to an example embodiment of the invention;

FIG. 2 shows a flow diagram showing operations in accordance with an example embodiment of the invention;

FIG. 3 presents an example block diagram of a client device in which various embodiments of the invention may be applied;

FIG. 4 presents an example block diagram of a server apparatus in which various embodiments of the invention may be applied; and

FIG. 5 shows a flow diagram showing phases in accordance with an example embodiment of the invention.

### DETAILED DESCRIPTION OF THE DRAWINGS

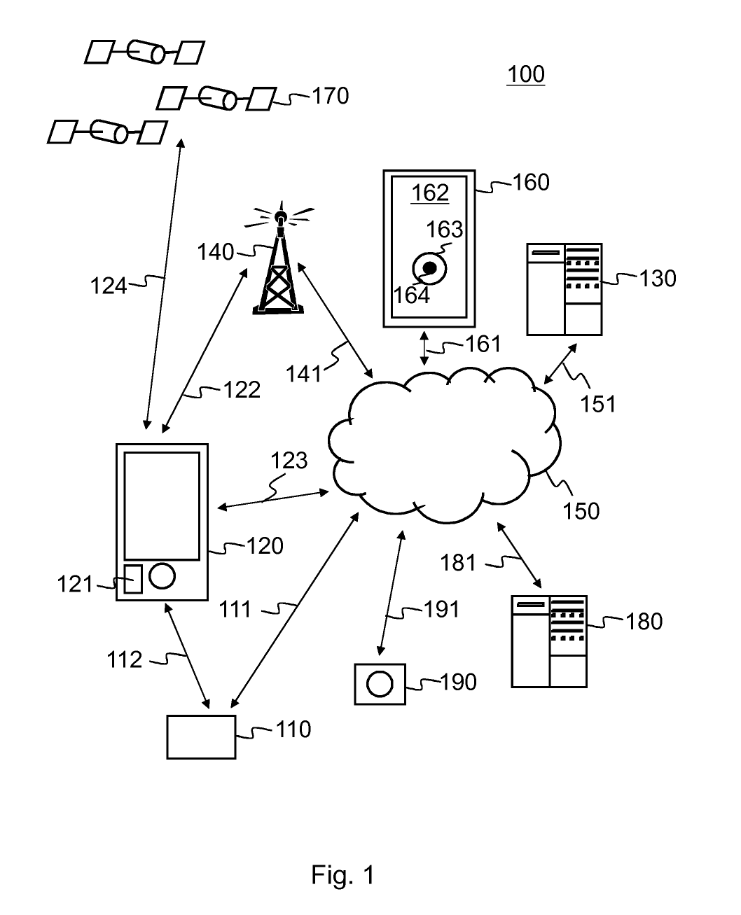

An example embodiment of the present invention and its potential advantages are understood by referring to FIGS. 1 through 5 of the drawings. In this document, like reference signs denote like parts or steps.

FIG. 1 shows a schematic picture of a system 100 according to an example embodiment of the invention. The system 100 comprises a client device 120 that may comprise a multimedia device, a mobile phone, an Internet tablet or a laptop computer, for example. The client device 120 is capable of downloading and locally executing software program code. The software program code may be a client application of a service whose server application is running on the server apparatus 130 of the system 100.

In an embodiment, the client device 120 may comprise multimedia-capturing element, such as a camera, for capturing multimedia, such as still images or video streams, for example. The client device 120 may also have a scanning device 121 for creating data usable for making a service order request or tracing status of an already placed order. The scanning device 121 may comprise at least one of the following: a sensor for detecting a series of characters, an unique e-mail address, or a pictogram; or a reader for detecting a bar code, or a quick response (QR) code; or a RF-ID reader for detecting a RF-ID (Radio Frequency IDentification) chip; or a NFC-reader for detecting a NFC (Near Field Communication) chip. The RF-ID chip or the NFC chip may comprise, for example, any kind of tag, such as passive, active, or any combinations thereof. Furthermore, the device 120 may comprise, for example, a microphone, a positioning device for determining the current location of the client device 120, and a clock. The client device 120 is configured to be connectable to a wireless communication network 140 over a wireless connection 122. The wireless connection 122 may comprise a mobile cellular network or a wireless local area network (WLAN), for example. The wireless communication network 140 may be connected to a public data communication network 150, for example to the Internet, over a data connection 141.

The system 100 may comprise a plurality of satellites 170 in orbit about the Earth. The orbit of each satellite 170 is not necessarily synchronous with the orbits of other satellites and, in fact, is likely asynchronous. A global positioning system receiver apparatus such as the client device 120 in connection with preferred embodiments of the present invention is shown receiving spread spectrum global positioning system (GPS) satellite signals 124 from the various satellites 170.

In an embodiment, the system 100 further comprises a system server apparatus 130, which comprises a storage device for storing order request related data, such as ordered items, packaging types for delivering an ordered item for a client based on the order request, unique identifiers for packaging items of the determined packaging type; associations of the unique identifiers with the clients and the order requests; generated order status information, and feedback information for the client based on the order status information. The system server 130 may communicate with other devices over a data connection 151, for example. The system server 130 may also comprise a plurality of servers.

In an embodiment, the system server apparatus 130 may comprise information on different items available for orders and different packaging items. Thus, the system server apparatus 130 may process the order request and determine the optimal packaging item for the ordered item. Such determination may depend on size, number, temperature of the ordered item or profile information attributes of the client, for example.

In an embodiment, the system 100 may further comprise a payment server 180, such as a debit or a credit payment server, for example. The client may pay the ordered item with a card, and thus a request is sent to the credit/debit server 180. Alternatively, the client may pay with cash and the operator system server 130 acknowledges the payment. After reception of the payment, clearance is given for further processing of the order request. The payment server 180 may also be comprised by the system server 130.

In an embodiment, the system 100 comprises a smart table 160. The smart table may be a customer smart table within a restaurant or cafeteria, or the smart table 160 may be a service provider smart table where ready made orders are placed for picking up by clients. The smart table 160 may also be a combination of both types. The smart table 160 comprises at least one active area 162 that is capable of interacting with clients or items on top of the area 162. For example, the active area 162 may comprise a scanning device for detecting unique identifiers attached to packaging items on top of the active area 162. Furthermore, the active area 162 may also comprise display means to provide information to clients or operators in any location of the active area 162. For example, a packaging item 163 with a unique identifier 164 may be detected and further additional information for the ordering client may be provided adjacent to the packaging item on the active area 162. The smart table may comprise a touch sensitive display and the smart table 160 may be connected to a network 150 over a local connection 161.

In an embodiment, the system 100 comprises at least one scanning device 110, 190. The scanning device 110, 190 may comprise, for example, a scanner integrated to a service desk relating to a process for delivering the ordered item for the client based on the order request; a smart table 160; a scanner 121 integrated to a client device 120; a handheld scanner 190 operated by a service provider employee; and a scanner 110 integrated to a service provider machine processing the ordered item.

In an embodiment, an anonymous ordering process is assisted with a help of individually marked packaging items. A unique identifier 164 is attached to a single packaging item, such as a packaging item 163. The unique identifier 164 makes the packaging item 163 differ from one another and thus each packaging item can be unambiguously identified.

The unique identifier 164 can be information that is unique in the true sense of the word: in a life time of an ordering process the identifier only appears once. However for practical reasons unique could mean unique during an ordering year, month, week, day or hour, for example.

An anonymous ordering process may be understood to be an ordering process in which initially no contact exists between an ordering client or client device 120 and a supplier of to-be-ordered goods (operator of system server 130 and/or smart table 160). Because of the absence of earlier contact, allocation of an ordered item to the ordering client is problematic. Examples of such an anonymous ordering process comprise, for example, ordering with the help of a client device 120, such as an electronic ordering tablet or a smart phone; or with the help of a smart table 160.

The unique identifier 164 on the packaging item 163 solves the problem of allocating an order to an anonymous client. The unique identifier 164 on the packaging item 163, that is going to carry the order, substitutes the identity of an unknown client that generates an electronically transmitted order using, for example, the client device 120.

In an embodiment, order request related information may travel between the client device 120 and the system server 130 over different paths. A first path may comprise sending data provided by a proprietary application of a client device 120 over a wireless communication network 122, 140, 141 and public data communication network 150, 151 to the server apparatus 130. A second path may comprise sending data captured by a default application of a client device 120 over a wireless communication network 122, 140, 141 and public data communication network 150, 151 to the server apparatus 130. A third path may comprise sending data captured by an external device 110 to the client device 120 over connection 112 and therefrom over a wireless communication network 122, 140, 141 and public data communication network 150, 151 to the server apparatus 130. A fourth path may comprise sending data captured by the external device 110 over the connection 111 directly to the public data communication network 150, 151 and to the server apparatus 130. The external device 110 may comprise, for example, a smart table or an external tablet. As disclosed earlier, the device 110 may also comprise a scanner device.

In an embodiment, the proprietary application in the client device 120 may be a client application of a service whose server application is running on the system server 130 of the system 100.

The proprietary application may capture the data for the first path. Also metadata for the captured data may be retrieved by the proprietary application from the metadata elements of the client device 120. The default application may be, for example, an imaging application or a messaging application of the client device 120. For the second path, the data captured by the default application may be imported to the proprietary application before transmitting to the server 130. The proprietary application may check the data and extract and apply metadata for the data. For the third path, the data may be captured by the external device 110 and transmitted to the proprietary application of the client device 120 for sending to the server 130. The proprietary application may check the data and extract and apply metadata for the data. User may provide additional metadata using the client device 120. For the fourth path, the data may be captured by the external device 110 and transmitted to the network 150.

In a further embodiment, the client may access the order related data, after making an initial order request, on the server apparatus 130 and provide additional data or metadata. The proprietary or client application may be configured to control the client device 120 to capture data using for example a camera, a sensor, a RF-ID reader or a NFC reader to be used for processing data for the order request, before or during transmission the order request related data to the system server 130.

In an embodiment, a proprietary or client application in the smart table 160 and/or the external device 110 may be a client application of a service whose server application is running on the system server 130 of the system 100.

In an embodiment, a packaging item in a coffee shop contains a four digit code: “1002”. First, a client places an order request for an espresso ristretto using a client device, such as a smart phone. Once the order request is received by a system server, an operator takes the packaging item and enters the unique code of said packaging item into the system that received the order request. Now the order request and any other information that came with the order request and the packaging item are unambiguously linked. The number “1002” bridges the gap between anonymous customer and the ordered item.

In an embodiment, once the espresso is prepared, the operator can send this number back to the client via the opposite route of the original order entree. So the client device, such as a smart phone, receives status information of the order request. Status information may comprise intermediate status of the order within the order processing chain. At the latest, the status information will indicate when the ordered item is ready to be delivered to the client. For example, the client device may flash “1002” as feedback information, and the anonymous client is triggered to collect the packaging item with the number “1002”.

The above example uses a simple code. However, a unique identifier of the packaging item may carry more information, or can be automatically detectable and readable using a scanner device, for example. The unique identifier may comprise at least one of the following: a series of characters; an unique e-mail address; a RF-ID chip; a NFC chip; a bar code; a quick response (QR) code; and a pictogram.

In an embodiment, the system server may associate the unique identifier with additional information comprising at least one of the following: an identity of an external service or a database; a textual phrase; a reference to other unique information of the packaging item; a unique pictogram; a reference to a color; a promotional code; a lottery number; location information; and information assisting picking up the order.

Such additional information may be arranged to be readable by the client or the client device when the ordered item is ready to be delivered to assist the client to find his/her ordered item with the packaging item. The packaging item may be placed, for example, on a smart table, when the ordered item being ready to be delivered, and the smart table may detect the unique identifier and display the at least one of the unique identifier and the additional information for the client or the client device for assistance.

This additional information is also available for further processing by the system server and can be used either for further enhancing the electronic ordering process, or for other processes that accompany the ordering process, like e.g. promotional activities.

The unique identifier may be attached already in the production process of the packaging item. Thus, the packaging item comes “pre-programmed” with unique identifier.

In order to minimize mix-up of orders, the unique identifier could be part of the packaging item that actually contains or delivers the ordered item or goods. For example, preferred location is to add the identifier to a cup instead of adding the identifier to a lid.

In case the unique identifier, such as a bar code or a QR code, is placed to a bottom of the packaging item, such as a cup, and the packaging item is placed on a smart table during the processing chain, the identifier is easily detectable by a scanner device and status information may be generated automatically. The scanning device may be arranged on a working surface of a restaurant operator, for example, and be seamlessly integrated in that restaurant environment and the workflow of the operator.

In an embodiment, the working surface not only reads the code, put displays and relays information as well. This working surface is dubbed as smart table within this description.

The unique identifier may be added using digital print technologies, such as ink jet or laser printing technologies. However, the specific printing technologies used to apply the unique identifier on the packaging item are secondary to the embodiments. The digitally printed unique information can be a supplement to more generic imagery that has been applied with flexographic printing, offset, or rotogravure technologies.

In a preferred version of the system, the unique code is positioned at the bottom of a packaging item, whilst an automatic scanning device reads the code from that bottom.

In an embodiment, a packaging type may comprise information of a package and its size, such as a small/medium/large container, a small/medium/large cup, a small/medium/large plate, or a small/medium/large box, for example. A packaging item corresponds to a particular packaging used to deliver ordered item to a customer, such as a small cup for an espresso, or a large box for a vegetarian pizza.

In an embodiment, the system based on the unique identifier can be an add-on to an existing electronic ordering system and can be embedded inside a pre-existing electronic order processing.

In an embodiment, after an ordered item is delivered for a client, the client may sit down around a customer smart table 160 within a restaurant or cafeteria to enjoy the ordered item, such as a cup of coffee, for example. The smart table 160 comprises at least one active area 162 that is capable of interacting with clients or items on top of the area 162. For example, the active area 162 may comprise a scanning device for detecting unique identifiers attached to packaging items on top of the active area 162. Furthermore, the active area 162 may also comprise display means to provide information to clients or operators in any location of the active area 162. For example, a packaging item 163 with a unique identifier 164 may be detected and further additional information for the ordering client may be provided adjacent to the packaging item on the active area 162. The smart table may comprise a touch sensitive display and the smart table 160 may be connected to a network 150 over a local connection 161.

The smart table 160 may detect the unique identifier 164 of packaging item 163 after the ordered item is delivered for the client and provide a set comprising a plurality of user applications based on the unique identifier for the client to choose from. The client makes a decision and provides selection information for a user application of the plurality of user applications using a touch sensitive surface of the table 160, for example. In response to the received selection information the smart table 160 triggers the user application and the client may start using the application.

In an embodiment, the smart table 160 detects the unique identifier of packaging item after the ordered item is delivered for the client, and triggers a user application based on the unique identifier.

In case a client is identified by the system and the system comprises profile information for the client, the plurality of applications and selection of the application may be done based on the profile information.

In an embodiment, the user application comprises at least one of the following: a game application; an Internet browser application; a multimedia application; a social media application; and a commercial application.

In an embodiment, the packaging item may comprise a disposable item, such as plates, bowls, cups, utensils, doilies and tray papers. These items can be made from a number of materials including plastics, paper, cardboard, bio-resins and bamboo, for example.

In an embodiment, the profile information may comprise a user account. The user account may be a prepaid or postpaid account, for example, to be used for charges and compensations relating to at least one ordered item.

In an embodiment, the user profile may not identify the real identity of the user but to uniquely identify a client using a e-mail address, client number or such.

In an embodiment, the scanning device 190 may comprise, for example, a scanner integrated to a recycling bin. Such scanning device 190 of the recycle bin is configured to detect and read the unique identifier of a packaging item to generate status information for the system server. The status information in such case indicates that the packaging item is returned to the recycle bin. In response to such indication, the system server may be configured to allocate balance credits to the user account and/or allocate content rewards to the user to be maintained by the user profile information, for example. The content rewards may comprise, for example, magazines, games, music, TV show viewing and/or downloading rights.

In an embodiment, on other scenario, recycling deposit is held from the client at the point of sale and returned when the packaging item is correctly recycled. The unique code can also hold information on the packaging materials that can be used further down the recycling value chain or by the brand owner.

In an embodiment, the order request may comprise a plurality of ordered items to be delivered to the client using the same packaging item. For example, the client may order a plurality of drinks and receive the packaging item, such as a plastic cup, associated with the unique identifier when receiving the first ordered item (the first drink). Then again, when the client has emptied the plastic cup, he/she may go ahead and refill the cup using a self-service re-filler, such as a tap, for example. The self-service re-filler may also comprise a scanning device 190 to detect each refilling of the packaging item (e.g. plastic cup). Thus each re-filling of the item may be reduced from the plurality of ordered items that were ordered and purchased originally by the order request made by the client. Such solution has number of advantages. First, the client may use the same packaging item and consumption of the items is reduced, thus making the service more cost-effective and environment friendly. Second, the service provider personnel are not necessarily required to re-fill and resources are freed for other tasks. Third, the client receives further ordered item more quickly.

In an embodiment, the client may not need to know how many re-fillings he/she would like to have when making the original purchase. He/she may originally order only a single item and then carry out re-filling as disclosed above and the system server detects each re-filling using the scanning device 190 of the re-filler and charge the client via the user account. Thus the ordered items may be dynamically adjusted based on unused credits of the client's user account. Furthermore, automatic card crediting may be applied based on number of usage occasions even if there are unused credits within the user account, if there is a credit card associated to the user account, for example.

In an embodiment, usage controlling may be defined using the user account and/or the client profile information. For example, a maximum amount of a certain ordered items, such as beer pints or a hamburgers, may be defined to the user account and/or the client profile information to be able to be purchased within certain time period, such as within a day, week or month, for example.

In an embodiment, in response to detecting the packaging item with the unique identifier received by the recycling bin, the unique identifier may be made available for another disposable packaging item, for example.

In an embodiment, the client profile information maintained by the system server is used for promoting offerings based on client consumption history. History data is stored to the system server based on earlier client order requests. Furthermore, each client may define some personal food content information to the profile information, such as allergy information. Such information may be used when the client makes order requests and the system server may be configured to automatically detect if ordered items comprise any compounds that may be unsuitable for the client.

The multimedia application may enable the client to watch video streams, for example. The commercial application may provide commercials for the client of some special price goods and services, for example.

In an embodiment, the client can just sit in a cafeteria and put a coffee cup on the table 160. Then the table 160 comes to life and asks if the client wants to read daily news. The table 160 can communicate with the client by name if the system 100 already knows whose coffee cup is on the table 160. If the client wants to read the news, then the whole table 160 turns into a giant Internet tablet enabling the client to browse the news.

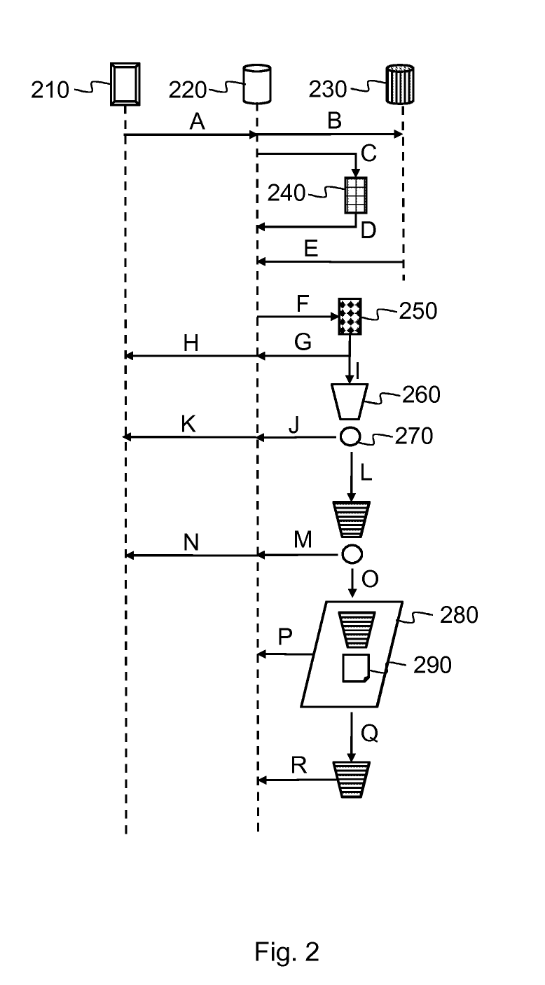

FIG. 2 shows a flow diagram showing operations in accordance with an example embodiment of the invention.

First, order request is provided. In phase A, a client orders with a client device 210, such as a smart phone. In phase B the system server has received the order and sends a request to a credit/debit server 230 for payment if the client pays with a card, for example. After processing the payment successfully by the credit/debit card server 230, an acceptance is transmitted to the system server in phase E for further processing of the order. If the client pays with cash, the system server provides invoicing information 240 in phase C to the client and after the client has paid the invoice, clearance is transmitted back to the system server in phase D for further processing of the order.

Second, payment is processed for the order request. In phase F the system server prepares order information 250 comprising e.g. a delivery estimate, maintains the order information at the system server in phase G and, if desired, sends the order information 250 with the delivery estimate to the client in phase H. At the same time, the order is added to the production cue in phase I. In an embodiment, the system may request location information of the client device 120, estimate the time consumed for the client to fetch the ordered item using the location information, and determine estimated time for the client to start moving towards the service provider to arrive just in time without needing to wait at the service provider.

Third, the order is prepared and delivered. An operator of the system server starts with an order by determining a packaging type for delivering an ordered item for the client based on the order request. A unique identifier is provided for a packaging item 260 of the determined packaging type, and the unique identifier is associated with the client and the order request. In phase J, the unique identifier is scanned by a scanning device 270 to generate order status information for the system server, as well as the association of the unique identifier with the client and the order request. The system server may then send feedback information in phase K for the client based on the order status information. Sending feedback information may be an optional feature, however.

In phase L, the order is processed and may comprise a plurality of steps and even a plurality of items comprised by a single order.

In phase M, the operator has fully prepared the order request and the unique identifier is scanned again to indicate that the order is ready. The customer is informed as well in phase N.

Before the client picks up the packaging item, the operator may put the packaging item on a smart table 280 in phase O. Using the smart table 280 additional information 290 associated with the unique identifier to the client for assisting picking up of the ordered item may be provided. Such information 290 may be depicted next to the packaging item. Thus the customer can recognize the ordered item. Any other order items that might have been ordered by the same client may be placed in a group that is destined for said client. In this way order items that follow a different production route can be easily regrouped for the convenience of the client.

In phase P the smart table reads the unique identifier and informs the system server. After phase Q, when the client has picked up the packaging item with the order, the smart table 280 may inform the system server 220 to end the delivery process in phase R.

Fourth, after sales features (not shown) may be provided after phase R. The client may read the unique identifier (e.g. QR code) with a client device 210 and connect with the system server 220 with the client device 210. The system server may send digital content back to the client device, for example.

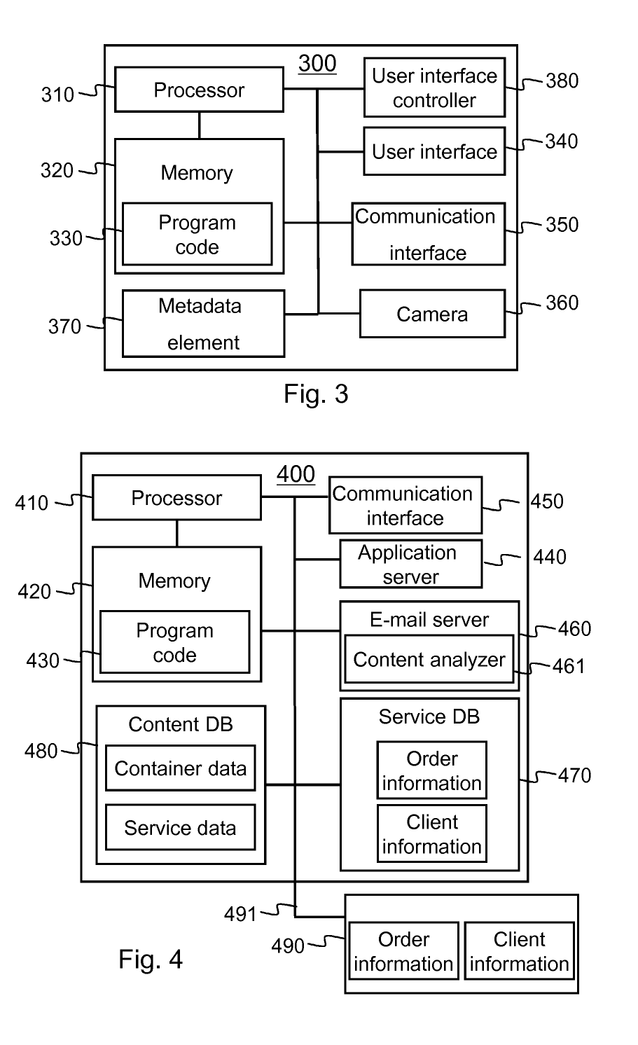

FIG. 3 presents an example block diagram of a client device 300 in which various embodiments of the invention may be applied. The client device 300 corresponds to the client device 120, 210 disclosed in FIGS. 1 and 2. The client device 300 may be a multimedia device, a user equipment (UE), a user device or an apparatus, such as a mobile terminal, a smart phone, a tablet or other communication device.

The general structure of the client device 300 comprises a user interface 340, a communication interface 350, a metadata element 370, a camera 360, a processor 310, and a memory 320 coupled to the processor 310. The client device 300 further comprises software 330 stored in the memory 320 and operable to be loaded into and executed in the processor 310. The software 330 may comprise one or more software modules and can be in the form of a computer program product. The software 330 may also provide metadata information relating to the software and hardware of the client device 300. The client device 300 may further comprise a user interface controller 380.

In an embodiment, the at least one memory 320 and the computer program code 330 are configured to, with the at least one processor 310, cause the client device 300 to transmit an order request for at least one ordered item to a system server for associating, by the system server, a unique identifier with a client and the order request, wherein the unique identifier being attached to a packaging item for delivering an ordered item for the client; and for detecting, by a scanning device, the unique identifier to generate order status information for the system server.

Furthermore, the client device 300 may be configured to receive feedback information generated by the system server based on order status information, wherein the order status information being generated using a detected unique identifier received from a scanning device; the unique identifier being associated with the client and the order request by the system server; and the unique identifier being provided for a packaging item of a determined packaging type; and further wherein the packaging type being determined for delivering an ordered item for the client based on the order request.

The processor 310 may be, e.g., a central processing unit (CPU), a microprocessor, a digital signal processor (DSP), a graphics processing unit, or the like. FIG. 3 shows one processor 310, but the client device 300 may comprise a plurality of processors.

The memory 320 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The client device 300 may comprise a plurality of memories. The memory 320 may be constructed as a part of the client device 300 or it may be inserted into a slot, port, or the like of the client device 300 by a user. The memory 320 may serve the sole purpose of storing data, or it may be constructed as a part of a device serving other purposes, such as processing data. A proprietary application, a client application, a default application and order related data may be stored to the memory 320.

The user interface controller 380 may comprise circuitry for receiving input from a user of the client device 300, e.g., via a keyboard, graphical user interface shown on the display of the user interfaces 340 of the client device 300, speech recognition circuitry, or an accessory device, such as a headset, and for providing output to the user via, e.g., a graphical user interface or a loudspeaker.

The metadata element 370 comprises element configured to provide metadata information. Such elements may comprise, for example, a positioning device, an accelerometer, a temperature gauge, a clock or a microphone. The client may, for example, attach the client device 300 location to the order request or record a voice message for further instructions or requests relating to the order.

The camera 360 may be a still image camera or a video stream camera, capable for creating order related data and providing metadata information for the order related process.

The communication interface module 350 implements at least part of radio transmission. The communication interface module 350 may comprise, e.g., a wireless or a wired interface module. The wireless interface may comprise such as a WLAN, Bluetooth™, infrared (IR), radio frequency identification (RF-ID), near field communication (NFC), GSM/GPRS, CDMA, WCDMA, or LTE (Long Term Evolution) radio module. The wired interface may comprise such as universal serial bus (USB), for example. The communication interface module 350 may be integrated into the client device 300, or into an adapter, card or the like that may be inserted into a suitable slot or port of the client device 300. The communication interface module 350 may support one radio interface technology or a plurality of technologies. The client device 300 may comprise a plurality of communication interface modules 350. Generated order related data may be transmitted and received via a wireless communication network using the communication interface 350.

A skilled person appreciates that in addition to the elements shown in FIG. 3, the client device 300 may comprise other elements, such as microphones, extra displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the client device 300 may comprise a disposable or rechargeable battery (not shown) for powering when external power if external power supply is not available. In an embodiment, the client device 300 comprises speech recognition means. Using these means, a pre-defined phrase may be recognized from the speech and translated into a metadata tag. This tag may then be used as any other metadata, for example for characterizing the order related data or for grouping orders together, for example.

In an embodiment, a signature of the client may be generated for the order request or the payment verification using the client device 300. The signature may comprise at least one of the following: handwritten signature of the client stored by client device 300; digital identification (ID) provided for the client device 300; fingerprint signature; voice signature; and retina signature detected by the client device 300. Digital ID may replace both client ID detection step and signature step.

Handwritten signature may be received by the user interface 340, such as a touch sensitive display that receives a handwritten signature by the client, for example.

Fingerprint signature may be received by the user interface 340, by the camera 360 or by the metadata element 370, such as a fingerprint sensor.

Voice signature may be received by the speech recognition means of the client device 300.

Retina signature may be received by the camera 360 or the metadata element 370 of the client device 300.

Not all elements of FIG. 3 are required to be included in all client devices 300. For example the camera 360 and the metadata element 370 are not needed necessarily.

FIG. 4 presents an example block diagram of a server apparatus 400 in which various embodiments of the invention may be applied. The server apparatus 400 may comprise at least one of the system server 130, 220 and the payment server 180, 230.

The general structure of the server apparatus 400 comprises a processor 410, and a memory 420 coupled to the processor 410. The server apparatus 400 further comprises software 430 stored in the memory 420 and operable to be loaded into and executed in the processor 410. The software 430 may comprise one or more software modules and can be in the form of a computer program product.

The processor 410 may be, e.g., a central processing unit (CPU), a microprocessor, a digital signal processor (DSP), a graphics processing unit, or the like. FIG. 4 shows one processor 410, but the server apparatus 400 may comprise a plurality of processors.

The memory 420 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The server apparatus 400 may comprise a plurality of memories. The memory 420 may be constructed as a part of the server apparatus 400 or it may be inserted into a slot, port, or the like of the server apparatus 130 by a user. The memory 420 may serve the sole purpose of storing data, or it may be constructed as a part of an apparatus serving other purposes, such as processing data.

The communication interface module 450 implements at least part of radio transmission. The communication interface module 450 may comprise, e.g., a wireless or a wired interface module. The wireless interface may comprise such as a WLAN, Bluetooth, infrared (IR), radio frequency identification (RF-ID), near field communication (NFC), GSM/GPRS, CDMA, WCDMA, or LTE (Long Term Evolution) radio module. The wired interface may comprise such as universal serial bus (USB), for example. The communication interface module 450 may be integrated into the server apparatus 400, or into an adapter, card or the like that may be inserted into a suitable slot or port of the server apparatus 400. The communication interface module 450 may support one radio interface technology or a plurality of technologies. The server apparatus 400 may comprise a plurality of communication interface modules 450. Order request or order request related data may be transceived with the client device 300, scanning devices and other servers using the communication interface 450.

The e-mail server process 460, which receives e-mail messages sent from client devices 300 and other apparatuses via the network 150. The server 460 may comprise a content analyzer module 461, which checks if the content of the received message meets the criteria that are set for new content data relating to an order request in the service. The content analyzer module 461 may for example check, whether the e-mail message contains a valid order item. The valid content data received by the e-mail server is then sent to an application server 440, which provides application services e.g. relating to client information, order request related information or similar stored in a service database 470 and content of the content management service. In the service database 470, order request status information, feedback information and additional information for order requests may also be stored. The service information may also be stored in the external apparatus 490, wherein data may be stored over a data connection 491. The data connection 491 may comprise several connections, such as the connection 151 and the Internet 150 of FIG. 1, for example.

The order request information stored in either of the server apparatus 400 or the external apparatus 490 may comprise order requests for service or goods within a certain geographical location with a certain radius, for example. Furthermore, client location information may be stored in the service database 470 or in the external apparatus 490. The client location information may comprise location information of client having pending order requests and their registered hotspots or current location. The system server may use location information for generating status information and estimate when the order is ready to be picked up and even when the client should start moving for the destination to pick up the order.

Content provided by the service system 100 is stored in a content database 480. The database 480 may comprise packaging item data, unique identifiers, packaging type data, available service and goods to be ordered, pricing information and similar needed for the order request process.

A skilled person appreciates that in addition to the elements shown in FIG. 4, the server apparatus 400 may comprise other elements, such as microphones, displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like.

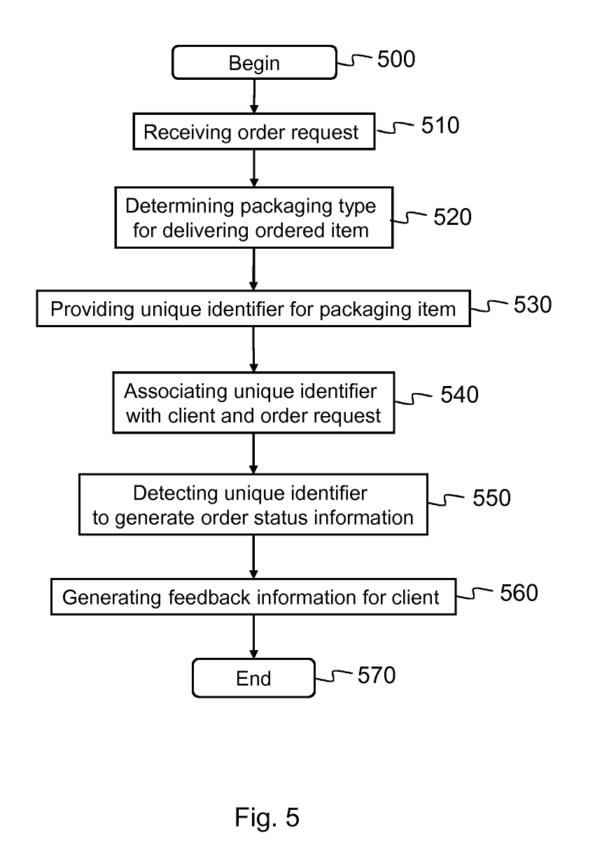

FIG. 5 shows a flow diagram showing operations in accordance with an example embodiment of the invention. In step 500, the method is started. In step 510, an order request is received, by a system server for at least one ordered item, from a client device. In step 520, a packaging type is determined for delivering an ordered item for a client based on the order request. In step 530, a unique identifier is determined for a packaging item of the determined packaging type. In step 540, the unique identifier is associated with the client and the order request. In step 550, the unique identifier is detected to generate order status information for the system server. In step 560, feedback information may be generated for the client based on the order status information. The method ends in step 570. All disclosed steps are not essential for the method to be carried out, such as steps 520-530, for example. Furthermore, steps may be carried out in different order as disclosed in FIG. 5 and by different devices.

Without in any way limiting the scope, interpretation, or application of the claims appearing below, a technical effect of one or more of the example embodiments disclosed herein is improved method and apparatus for providing electronic order request system for goods or services. Another technical effect of one or more of the example embodiments disclosed herein is improved order request system for anonymous clients. Another technical effect of one or more of the example embodiments disclosed herein is that enhanced status information of the pending order request may be provided. Another technical effect of one or more of the example embodiments disclosed herein is that clients picking up their orders are provided additional information to ease up location of their orders. Another technical effect of one or more of the example embodiments disclosed herein is that only a single system is needed for all, and no complex apparatuses are needed, and a wide variety of mobile devices, smartphones, tablets and computers may be used to provide access to the system. Another technical effect is that ordering process is faster since no attaching sticker or such to a packaging item when client ordering an item is needed, costs are reduced since no additional stickers are needed and furthermore less human resources are needed.

If desired, the different functions discussed herein may be performed in a different order and/or concurrently with each other. Furthermore, if desired, one or more of the before-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the foregoing describes example embodiments of the invention, these descriptions should not be viewed in a limiting sense. Rather, there are several variations and modifications, which may be made without departing from the scope of the present invention as defined in the appended claims.

1. A computer-implemented method comprising the steps of:
receiving, by a system server, an order request for at least one ordered item from a client device of a client;
determining, by the system server, a packaging type for containing and delivering the ordered item for the client based on the order request;
detecting, by a scanning device, a unique identifier of a packaging item of the determined packaging type, wherein the packaging item is a disposable packaging item, and wherein the unique identifier is attached to the packaging item during a manufacturing phase of the packaging item;
associating, by the system server, the unique identifier with the client and the order request;
detecting, by a scanning device, the unique identifier during or after the order request is processed to generate order status information for the system server; and
generating, by the system server, feedback information for the client based on the order status information.

2. The method of claim 1, wherein the unique identifier is positioned at a bottom of the packaging item, the scanning device detecting the unique identifier from the bottom.

3. The method of claim 1, wherein the unique identifier comprises at least one of the following:
a series of characters;
a unique e-mail address;
a RF-ID chip;
a NFC chip;
a bar code;
a QR code; and
a pictogram.

4. The method of claim 1, further comprising the step of:
transmitting, by the system server, the feedback information to the client device during the order request being processed and before the ordered item is ready to be delivered; or
transmitting, by the system server, the feedback information to the client device after the order request is processed and when the ordered item is ready to be delivered.

5. (canceled)

6. The method of claim 4, further comprising the step of:
providing additional information associated with the unique identifier to the client for assisting picking up of the ordered item.

7. (canceled)

8. The method of claim 6, further comprising the step of:
arranging at least one of the unique identifier and the additional information to be readable by the client or the client device when the ordered item is ready to be delivered.

9. (canceled)

10. The method of claim 1, wherein the scanning device comprises at least one of the following:
a scanner integrated to a service desk relating to a process for delivering the ordered item for the client based on the order request;
a scanner integrated to a client device;
a scanner integrated to a recycle bin;
a handheld scanner operated by a service provider employee; and
a scanner integrated to a service provider machine processing the ordered item.

11. The method of claim 10, wherein the scanner integrated to the recycle bin is configured to detect and read the unique identifier of the packaging item to generate status information for the system server, the status information indicating that the packaging item is returned to the recycle bin, and further in response to such indication, the system server is configured to allocate balance credits to a user account and/or allocate content rewards to the client to be maintained by user profile information maintained by the system server.

12. The method of claim 1, further comprising the steps of:
receiving, by the system server, an order request for a plurality of ordered items from the client device;
associating, by the system server, unique identifiers with the client and the order request, wherein a unique identifier is attached to each packaging item for containing and delivering the plurality of ordered items for the client;
detecting, by the scanning device, the unique identifiers to generate order status information for the system server; and
generating, by the system server, feedback information for the client based on the order status information.

13. (canceled)

14. (canceled)

15. (canceled)

16. (canceled)

17. (canceled)

18. (canceled)

19. (canceled)

20. The method of claim 1, wherein the order request comprises a plurality of ordered items to be delivered to the client using the same packaging item.

21. The method of claim 20, further comprising the steps of:
associating, by the system server, the unique identifier with the client and the order request with the additional information, wherein the unique identifier is attached to the packaging item for delivering the plurality of ordered items for the client; and
detecting, by a scanning device of a re-filler device, each re-filling of the packaging item.

22. The method of claim 21, wherein each re-filling of the packaging item is reduced from the plurality of ordered items that were ordered and purchased originally by the order request made by the client.

23. The method of claim 1, further comprising the step of:
in response to detecting the packaging item with the unique identifier is received by a recycling bin, the unique identifier is allocated available for another disposable packaging item.

24. A system server comprising:
a communication interface for transceiving data;
at least one processor; and at least one memory including computer program code, wherein the at least one memory and the computer program code are configured to, with the at least one processor, cause the system server to:
receive an order request for at least one ordered item from a client device of a client;
determine a packaging type for containing and delivering the ordered item for the client based on the order request;
detect a unique identifier of a packaging item of the determined packaging type, wherein the packaging item is a disposable packaging item, and wherein the unique identifier is attached to the packaging item during a manufacturing phase of the packaging item;
associate the unique identifier with the client and the order request;
receive the detected unique identifier from a scanning device during or after the order request is processed to generate order status information; and
generate feedback information for the client based on the order status information.

25. A computer program embodied on a computer readable medium comprising computer executable program code which, when executed by at least one processor of a system server, causes the system server to:
receive an order request for at least one ordered item from a client device of a client:
determine a packaging type for containing and delivering the ordered item for the client based on the order request;
detect a unique identifier of the packaging item of the determined packaging type, wherein the packaging item is a disposable packaging item, and wherein the unique identifier is attached to the packaging item during a manufacturing phase of the packaging item;
associate the unique identifier with the client and the order request;
receive the detected unique identifier from a scanning device during or after the order request is processed to generate order status information; and
generate feedback information for the client based on the order status information.

26. (canceled)

27. (canceled)

28. (canceled)
